(19) United States
(12) Patent Application Publication
(10) Pub. No.: US 2002/0087342 A1
(43) Pub. Date: Jul. 4, 2002

(54) Customer billing

(75) Inventor: David John Garvey, Wellington (NZ)

Correspondence Address: IBM Corporation, Intellectual Property Law Dept., P.O. Box 218, Yorktown Heights, NY, 10598, US

(73) Assignee: International Business Machines Corporation, Armonk, NY

(21) Appl. No.: 09/963,047

(22) Filed: Sep. 25, 2001

(30) Foreign Application Priority Data
Sep. 29, 2000 (NZ) 507238

(51) Int. Cl. G06F 17/60

(52) U.S. Cl. 705/1

(57) ABSTRACT

This invention provides methods, apparatus and systems for customer billing. During a billing cycle customer accounts which are to be billed are determined. The customers are then prioritized by calculating a priority value based on a billing parameter. The customer accounts are then processed in order of priority.

### FIELD OF THE INVENTION

This invention relates to processing and billing customer accounts. In particular it relates to prioritizing and distributing customer account information among a plurality of customer account processors for generating customer invoices, statements and the like.

### BACKGROUND TO THE INVENTION

Typically utility providers have a large number of customers which need to be billed regularly based on their usage of the utility. Such utilities can include telecommunications service providers, television service providers, power suppliers, water suppliers and the like. The billing process involves retrieving data relating to each customers usage of the utility, combining this with existing information stored relating to the customer, such as contact details and customer account balances, and supplying this information to billing systems which process the information to generate invoices, statements and the like. The billing process relates to usage during a particular billing period which is a length of time determined by the utility provider. Typically the billing period is either 4 weeks or one calendar month as this is a suitable length of time which enables billing to be done in a regular manner without being too often so as to be an inconvenience to either the utility provider or the customers.

As the utilities usually have a large customer base, the customer billing process requires a large amount of computer, monetary and human resource. As a result a number of techniques are implemented during bill generation to streamline the process. For example each customer is allocated to one of a number of billing cycles. A billing cycle relates to a billing period, such as a 4 week period, and each billing cycle is staggered so as to fall at a different time from the other billing cycles. For example a first billing cycle might run from Sep. 1, 2000 to Sep. 28, 2000, then from Sep. 29, 2000 to Oct. 26, 2000, then from Oct. 27, 2000 to Nov. 23, 2000 and so on. A second billing cycle would also have a 4 week billing period, however the cycle wall fall on different dates. For example the second bill cycle might run from Sep. 3, 2000 to Sep. 30, 2000, then from Oct. 1, 2000 to Oct. 28, 2000, then from Oct. 29, 2000 to Nov. 25, 2000 and so on. As many different staggered billing cycles as necessary can be used.

A billing process, also called a billing cycle run, will occur on or shortly after the completion of the current billing cycle. For example for the first billing cycle, a billing cycle run might be initiated on Sep. 29, 2000, the next on Oct. 27, 2000, the next on Nov. 24, 2000 and so on, with the resulting invoices or statements being sent to customers once the respective billing cycle run is completed. In this manner the processing of customer records is staggered such that only a subset of all customers are processed and billed at a particular time, rather than the entire customer base.

In a further efficiency measure, a typical billing system will implement multiple billing processors which operate in parallel. During a billing cycle run, customer usage information relating to the particular billing period will be distributed between a number of billing processors and in this manner a number of customer's accounts are processed simultaneously, thus speeding up the billing cycle run.

Typically for each run the customer accounts are processed in order of customer, for example customer 100001 will be processed first, customer 100002 will be processed second and so on. However this regime can introduce inefficiencies in the billing process where there are customers with high usage of the utility during the billing period as their accounts require a larger amount of processing resource. For example a commercial customer might have a higher usage of the utility than a residential customer, and therefore require a larger amount of bill processing resource. If these high usage customers are processed late in the billing cycle due to them having a bigger customer number then the billing process can be delayed. It would be preferable to have high usage customers processed early in the billing cycle run, with the lower usage customers being processed later during the billing cycle run.

### SUMMARY OF THE INVENTION

It is an object of the invention to provide a method, system, data structure and computer code on a computer readable medium which enables the prioritization of customers for processing during a billing cycle run.

In example embodiments, customers will be prioritized based on the total number of usage records relating to all their accounts, with more usage records corresponding to a higher customer priority. Customer accounts will then be processed during a billing cycle run in turn based on customer priority. The higher the customer priority, the earlier in the cycle the customer account will be processed.

In one aspect the present invention may be said to consist in a method for processing customer accounts during a billing cycle including: determining customers to be billed, prioritizing customers according to a billing parameter, and processing the accounts of customers in order of priority.

In another aspect the present invention may be said to consist in a system for processing customer accounts during a billing cycle including: a customer processor which determines customers to be billed, a priority processor which prioritizes customers according to billing parameters, and a billing subsystem which processes the accounts of customers in order of priority.

In another aspect the present invention may be said to consist in a computer readable medium containing computer code for an application which processes customer accounts during a billing cycle, the code enabling the steps of: determining customers to be billed, prioritizing customers according to billing parameters, and processing the accounts of customers in order of priority.

In another aspect the present invention may be said to consist in a data structure for a customer record in a billing system including: one or more information fields for specifying information relating to a customer, and one or more priority fields for specifying a customer priority, wherein the information in the priority field determines the order in which the customer record is processed during a billing cycle.

### BRIEF DESCRIPTION OF THE DRAWINGS

Advantageous embodiments of the invention will be described with respect to the drawings, in which:

FIG. 1 schematically shows a network including servers associated with billing processes,

FIGS. 2A, 2B show simplified customer data and transaction records respectively,

FIG. 3 outlines a process for assigning priority sequence numbers to customers according to total usage,

FIG. 4 outlines a process for determining priority sequence numbers by comparing total usage to a threshold,

FIG. 5 outlines a process for bill processing according to priority sequence numbers,

FIG. 6 outlines a general billing process on a server, and

FIG. 7 schematically shows hardware which may be used for implementing a subsystem of the invention.

### DETAILED DESCRIPTION OF THE ADVANTAGEOUS EMBODIMENTS

Referring to the drawings it will be appreciated that processing customer bills according to the invention may be implemented in various forms. The following embodiments are given by way of example only. Details relating to the customer billing systems themselves and the billing data will be known to those skilled in this area of technology and will not be discussed in detail.

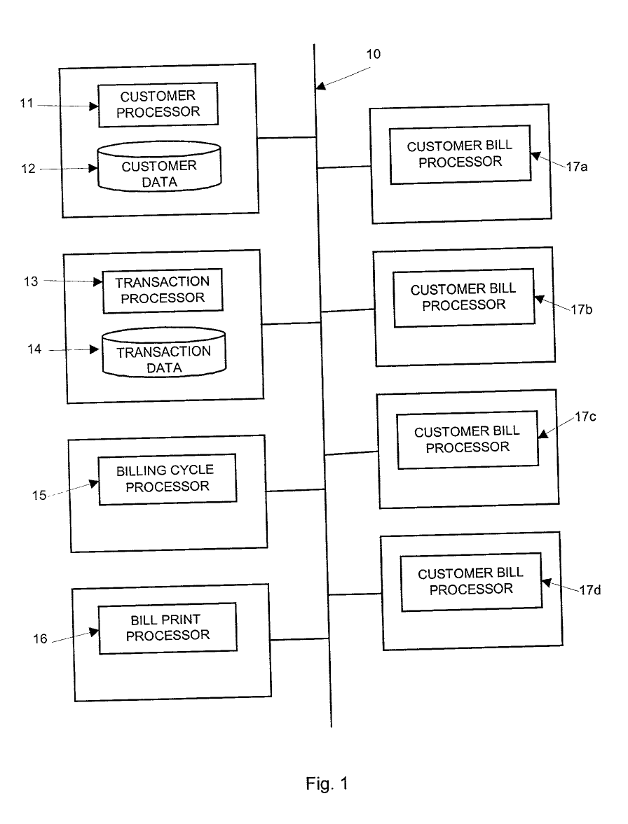

FIG. 1 shows a system 10 for processing customer bills in relation to usage of a utility or the like. The system 10 generally enables the accounts of high usage customers to be processed early in a billing cycle, with the accounts of lower usage customers being processed later in the billing cycle. It is envisaged that the billing system 10 will be utilized in the telecommunications industry although it will be appreciated that the invention is not limited to such use. The system 10 could also be implemented by television service providers, power suppliers, water suppliers or any other any customer account based company. The system 10 includes a customer processor 11 which accesses a database 12 containing customer related information such as contact details, account balances, customer history, special requirements and other necessary information which is required to facilitate processing of customer accounts. It will be appreciated that each customer may have more than one account. For example a customer may have two telephone accounts and a CATV account with the telecommunications service provider. The system 10 also includes a transaction processor 13 which accesses a database 14 containing information relating to the usage of the utility, in this case telephone calls made by the customer.

At intervals throughout a month, or other suitable billing period, billing cycle runs are initiated by the system 10 to assemble transactions for each customer and subsequently generate an account document such as an invoice or statement. During a billing cycle run or process the transaction processor 13 and customer processor 11 extract the necessary information for generating customer bills from the transaction database 13 and customer database 12 respectively. This information is passed to a billing cycle processor 15 which distributes the information among a plurality of customer billing processors 17a-17d in accordance with a distribution regime based on various billing parameters including a customer priority parameter.

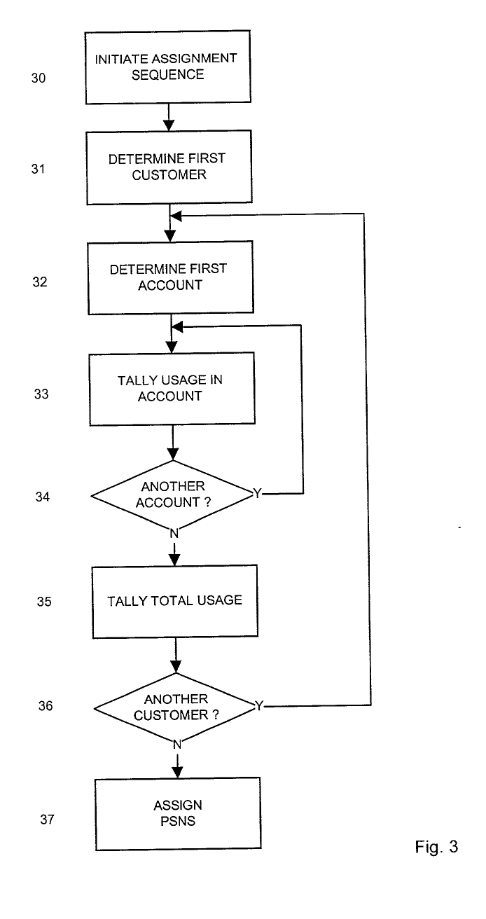

The customer priority will be allocated based on an appropriate qualifier or parameter relating to the nature of the customer records. In particular, the billing cycle processor 15 assigns a priority to each customer and then passes customer's billing information to the billing processors 17a-17d in order of priority. In this manner the accounts of higher priority customers are processed early on in the billing cycle to improve the overall efficiency of account processing for the billing cycle run. The nature of the distribution regime will be described in detail with reference to FIGS. 3-6. Billing processors 17a-17d correlate the information to update each customer's accounts receivable balance and history. Having multiple processors 17a-17d enables simultaneous processing of customer accounts from a single billing cycle to improve the speed of the invoice generation procedure. Once customer accounts from a billing cycle have been processed and all the corresponding accounts have been updated, account information is sent to a bill print processor 16 which generates the invoices for sending on to individual customers.

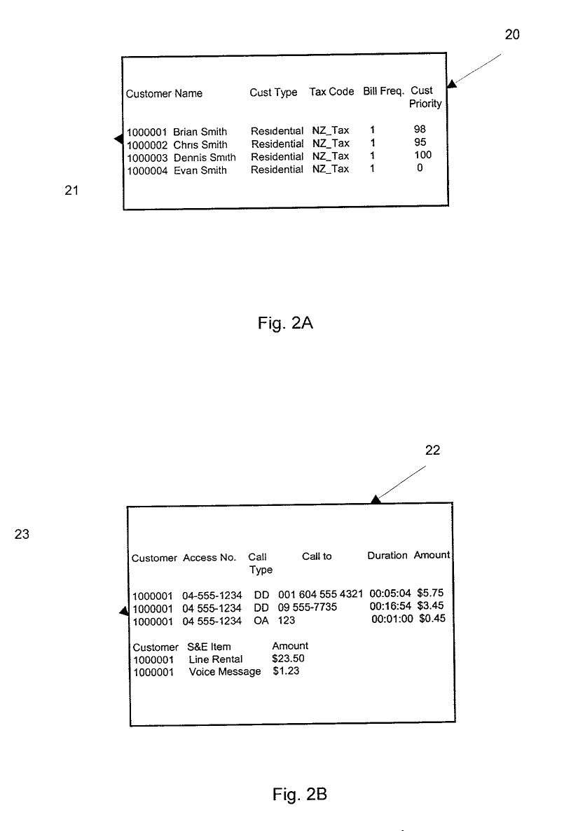

FIGS. 2a and 2b show an example of simplified customer data and transaction records respectively. A customer data file 20 includes a list of customer records 21 which specify for each customer a number, name, address, tax code, bill frequency per cycle and customer priority, also called a priority sequence number (PSN). It will be appreciated that various other information fields could be included in a customer record depending on the type information required for the billing process. A customer transaction file 22 includes a list of transaction records 23 which details customer usage of the telecommunications system. In this instance the information relates to telephone calls made by customer 1000001 (Brian Smith) during the billing period corresponding to the billing cycle being processed. Each record 23 specifies the customer number, in this case 1000001, the customer's telephone number, call type, destination number, duration, and call amount.

FIG. 3 shows a process for allocating PSNs to each customer in order for the bill processing to progress using a customer priority sequence. Each customer record is stored in a customer finance file and specifies information relating to the customer along with a billing cycle reference and an assigned PSN. The process includes a priority assignment function or program running in the bill cycle processor 15. The function is not run automatically for each billing cycle but rather the function is only initiated if a billing parameter is set, and if so initiates 40 the assignment sequence. In an advantageous embodiment the billing parameter is a “maintain priority sequence” flag specified in a cycle billing control maintenance file. If the flag is set to “yes” the priority sequence process will be initiated, otherwise if the flag is set to “no” the priority sequence will not be initiated, all priorities of customers comprising the bill cycle will be set to zero and the customer accounts will be allocated to the servers 17a-17d in a non prioritized manner. In an alternative embodiment, if the flag is set to “no” the priority sequence will not be initiated, however the existing priorities for each customer will remain unchanged. Some billing cycles may comprise predominantly residential accounts, which will have a relatively small number of usage records, and therefore do not require to be prioritized for allocation to the servers 17a-17d.

The allocation of priorities for a subsequent bill cycle run is implemented after the completion of the previous billing cycle run. In this manner the priorities are updated in time for use in the next bill cycle run. When the system 10 is first implemented the priority for all customers will be set to zero, that is, no priority. To set up the priorities, one bill cycle will need to be run with the “maintain priority sequence” flag set to Ayes”. The subsequent bill cycle run will then utilize the newly allocated priorities. Priority allocation can be based on any suitable qualifier or parameter which will enable efficient distribution of customer records between the customer bill processors 17a-17d. Advantageously the allocation of a PSN to a customer will be based on the total number of usage records which exist in all accounts for that customer. After initiating the assignment sequence 30, the function determines the first customer 31 in the customer finance file, and then determines 32 an account associated with the customer and tallies the number of usage records 33 for the account. This process is repeated 34 for each account associated with the first customer until a total usage record 35 is calculated. The function then determines the next customer from the customer finance file and calculates a total usage tally 35 for usage in all accounts associated with that customer. This process is continued until a usage tally has been calculated for all customer accounts. The program then writes a usage summary file detailing each customer in the bill cycle run and their number of usage records, each customer record being stored in descending order of the number of usage records associated with the customer. This information is used to assign the PSNs 37 to each customer.

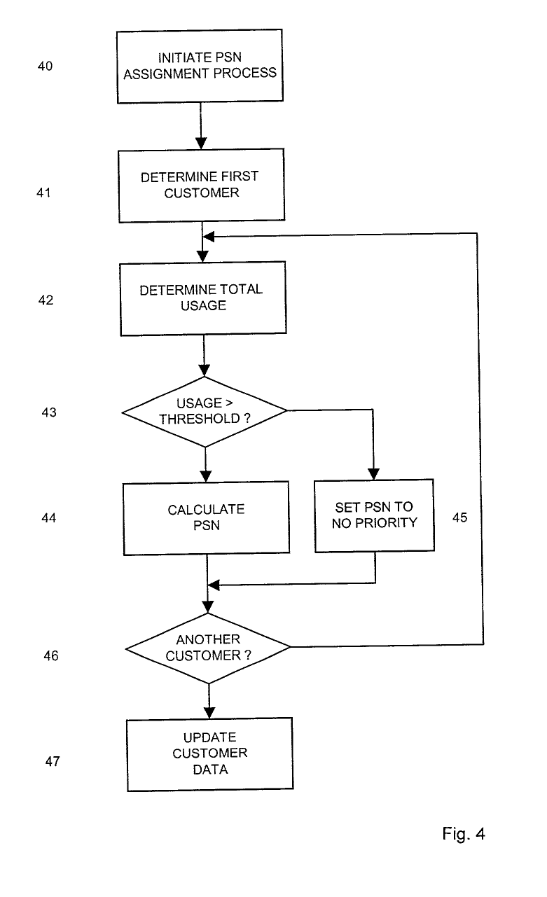

FIG. 4 shows in more detail the PSN assignment process. The usage summary file is read by the assignment function to determine the first customer 41 and subsequent customers in order of number of usage records. For each customer the number of usage records is determined 42 from the usage summary file. This number is then compared 43 to a threshold value which is specified in a “priority compare threshold” field of a global billing parameters file. In the advantageous embodiment this threshold is set at 50000 although it will be appreciated any suitable threshold value could be specified. If the number of usage records for a customer does not exceed the threshold then the PSN is set to zero 45 or “no priority”. Otherwise the assignment function calculates the PSN 44. In an advantageous embodiment, the customer with the most usage records is set a with priority label or number 99000. The customer with the second most usage records is allocated a priority number of 98999 and so on. If any customers have the same number of usage records they are allocated the same priority number. If a calculated priority number for a customer is zero or less then the priority number is set to 1. It will be appreciated that any suitable starting number or other type of priority label could be used for the priority, a priority label need not be numeric. Once all customers have been assigned a priority, the PSN fields in the customer finance file and other relevant customer data files are updated 47 to specify the assigned priorities for the customers.

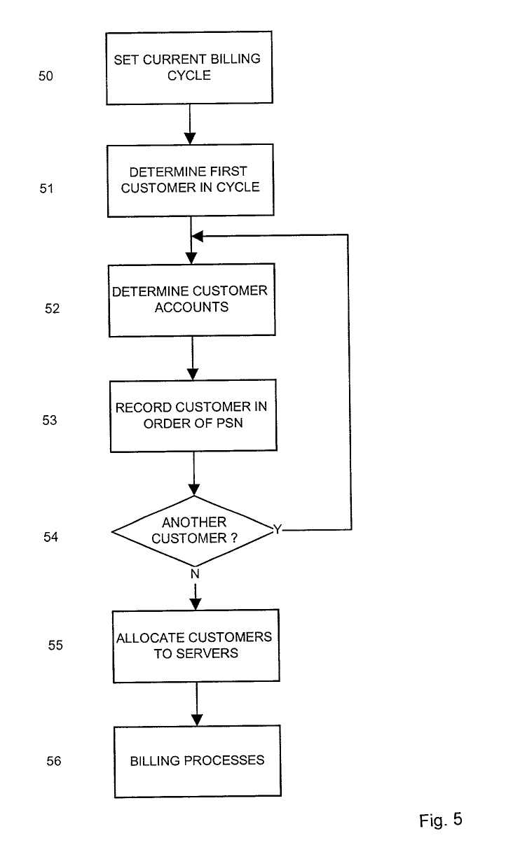

FIG. 5 shows an advantageous process undertaken by the billing cycle processor 15 for distributing customer billing information to billing servers 17a-17d based on customer priority. When the current billing cycle run is set up 50, the first customer in the billing cycle is read 51 from the customer finance file using a selection program. Further, as each customer may have more than one account, all the accounts associated with the first customer are also determined 52. The customer record is then stored in a file in order of billing cycle and PSN 53. At this point the selection program checks 54 to see if there are further customer records in the customer finance file. If so the associated accounts are determined 52 and the customer record is stored in a work file in order of billing cycle and PSN 33. Once all customer records for the billing cycle have been retrieved from the customer finance file and stored, then the billing cycle processor 15 allocates the customer information in the records to the bill processing servers 17a-17d based on the PSN 35. That is, the highest priority customer accounts are passed to the billing servers 17a-17d for processing first and once processing is completed the next highest priority customer accounts are passed to the billing servers 17a-17d for processing and so on.

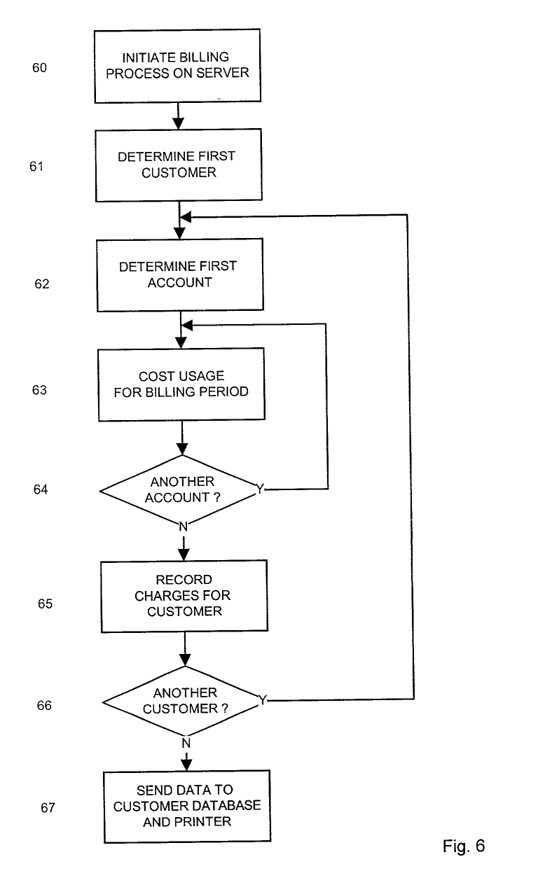

FIG. 6 shows in more detail the general process shown in steps 55 and 56 for allocating customer records to the billing servers 17a-17d for processing. Upon initiation of the allocation and billing process 60 the first customer record is retrieved 61 from the work file which contains all customer records for the billing cycle in order of PSN. The usage information relating to the first account for the customer 62 is retrieved and a total invoice amount for the billing period for the first account is calculated 63. The usage information for each subsequent account of the first customer is then retrieved and an invoice total is calculated 63. Once all accounts for the first customer have been processed the invoice totals are recorded in a file 65. The second and subsequent customers are then processed in order of priority in the same manner until invoice data for all customers and their accounts for the billing period have been generated. At this point the invoice data is sent to the customer database 12 to update the respective customer account balances and the invoice data is also sent to the bill print processor 16 to generate the individual customer invoices for sending out. It will be appreciated that in the advantageous embodiment of the system 10 multiple billing processors 17a-17d will all be implemented in parallel and therefore will all be accessing the work file simultaneously to retrieve customer records in order of PSN for account processing.

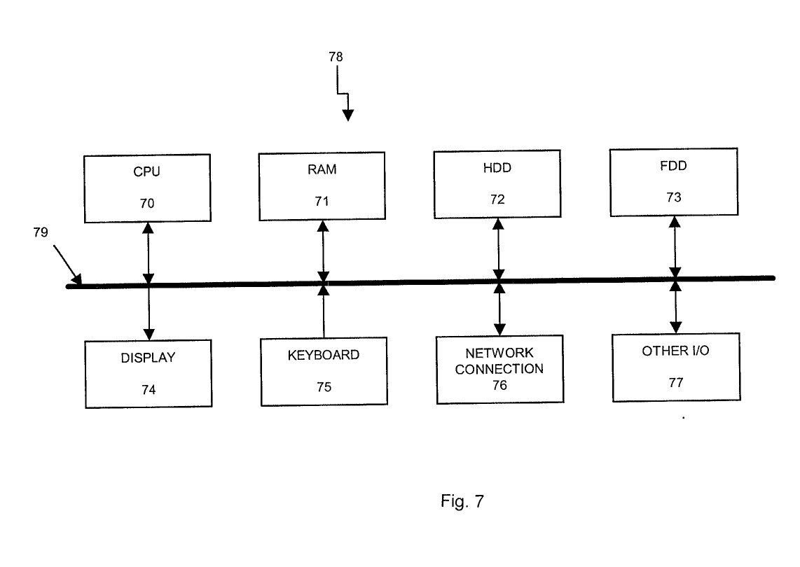

FIG. 7 shows an example of a computer subsystem 78 which may form part of the billing cycle processor 15 for implementing the invention. The system 78 includes a databus 79 which interconnects a CPU 70, RAM 71, monitor or other display 74, keyboard 75, network connection 76 and other input/output 77 components. The system 78 has a storage device such as a hard disk drive 72 for storing information and/or computer code as required. The system 78 also includes reading devices for a computer readable medium such as a floppy disk drive 73, CDROM drive or any other device which will be known to those skilled in the art. Code for implementing the invention can be stored on floppy disk, CDROM or other suitable computer readable medium for loading into the system's RAM 71 or onto the hard drive 72 as required.

The invention would typically be implemented in a utility provider such as a telecommunications or television service provider, or a power supplier. The invention, however, is not limited to such use and could be implemented in any customer account based company.

What is claimed is:

1. A method for processing customer accounts during a billing cycle including:
determining customers to be billed,
prioritizing customers according to a billing parameter, and
processing the accounts of customers in order of priority.

2. A method according to claim 1, wherein prioritizing the customers includes assigning a priority label to a customer based on the number of billing records associated with the customer.

3. A method according to claim 1, wherein a billing parameter is associated with each customer and relates to the number of billing records for that customer.

4. A method according to claim 2, wherein a customer with a larger number of records has a higher priority than a customer with a smaller number of records.

5. A method according to claim 4, wherein a zero priority label is assigned to a customer if the number of records for the customer is less than a threshold.

6. A system for processing customer accounts during a billing cycle including:
a customer processor which determines customers to be billed,
a priority processor which prioritizes customers according to billing parameters, and
a billing subsystem which processes the accounts of customers in order of priority.

7. A system according to claim 6, wherein the priority processor assigns a priority label to a customer based on the number of billing records associated with the customer.

8. A system according to claim 6, wherein a billing parameter is associated with each customer and relates to the number of billing records for that customer.

9. A system according to claim 7, wherein a customer with a larger number of records is assigned a higher priority label than a customer with a smaller number of records.

10. A system according to claim 9, wherein a zero priority label is assigned to a customer if the number of records for the customer is less than a threshold.

11. A computer readable medium containing computer code for an application which processes customer accounts during a billing cycle, the code enabling the steps of:
determining customers to be billed,
prioritizing customers according to billing parameters, and
processing the accounts of customers in order of priority.

12. A computer readable medium according to claim 11, wherein prioritizing the customers includes assigning a priority label to a customer based on the number of billing records associated with the customer.

13. A computer readable medium according to claim 11, wherein a billing parameter is associated with each customer and relates to the number of billing records for that customer.

14. A computer readable medium according to claim 12, wherein a customer with a larger number of records is assigned a higher priority label than a customer with a smaller number of records.

15. A computer readable medium according to claim 14, wherein a zero priority label is assigned to a customer if the number of records for the customer is less than a threshold.

16. A data structure for a customer record in a billing system including:
one or more information fields for specifying information relating to a customer, and
one or more priority fields for specifying a customer priority,
wherein the information in the priority field determines the order in which the customer record is processed during a billing cycle.
